(19) United States
(12) Patent Application Publication
(10) Pub. No.: US 2004/0160457 A1
(43) Pub. Date: Aug. 19, 2004

(54) Process for preparing customized posters, banners and trade show graphics

(76) Inventor: Mitch Termotto, Winston-Salem, NC (US)

Correspondence Address: Charles Y. Lackey, Post Office Box 5871, Winston-Salem, NC, 27113-5871, US

(21) Appl. No.: 10/368,034

(22) Filed: Feb. 19, 2003

(51) Int. Cl. G09G 5/00

(52) U.S. Cl. 345/619

(57) ABSTRACT

A process for preparing signage such as posters, banners, trade show graphics and other similar items that permits customization through the use of a selection of media types, images and finishings. Customers select a media, an image and a finishing, and desired printing and graphics are printed on the background of the chosen media either by the supplier of the media, background design and furnishing or by a selected printer signmaker.

### BACKGROUND OF THE INVENTION

1. Field of the Invention

The present invention is directed to a process for preparing customized sinage for display and, more particularly, to such a process that includes providing a selection of media on which to apply desired graphics from an inventory of different media, offering a library of images on which to apply desired graphics, offering a selection of finishings, and thereafter applying the desired graphics on the selected background design media having the selected finishing.

2. Description of the Prior Art

Posters and banners advertising or announcing a coming event promoting particular products and services are usually prepared in total by a supplier skilled in developing and producing such materials as a total customized project selecting the materials, background, trim and graphics for the customers' approval or correction. A number of changes are usually requested by the customer which often prompt the supplier to make other changes to make all phases of the project compatible and consistent This procedure often results in a rather expensive final project particularly when the needed volume of posters or banners is low. The cost of custom printing a small quantity or batch results in a price for such items being substantially higher than the prices of convention non-custom produced posters or banners.

Partial customization has been done to the extent that printed signage may be prepared for purchase that have some generally used printed message and blanks and voids that can be completed by the purchaser with more specific messages. While this technique keeps the price of the posters or banners within reason, the finished product often lacks the professional appearance and graphic specificity desired. Thus there is needed a technique or method of preparing and providing finished signage that will be graphically appealing and attractive without the high cost normally associated with such finished products. It is to that specific need that the present invention is directed.

### BRIEF SUMMARY AND OBJECTIVE OF THE INVENTION

The present invention is directed to a process for preparing signage such as posters, banners, trade show and retail graphics, and other similar items. A collection or inventory of differing media and finishings and a library of images are obtained and catalogued by the supplier which are made available to those customers who have specific or more general needs for such products. The customer can then select the media it prefers from the media inventory, the image it prefers from the library of images and the finishing it likes from the finishing options. The supplier can sell the selectively formed sign to a printer or signmaker who will add vinyl or custom graphics for the end user, or customize the desired graphics and sell the entire completed product to the end user, In either case, the furnished product is either partially customized with customer selected media, image and finishing or filly customized customer selected media, image and finishing and approved printed and other graphic material furnished by the supplier. Thus the finished product can be highly visible, professionally prepared and presented and message specific and not necessarily expensive. The media can be selected from banner material, adhesive vinyl, canvas, paper, corrugated plastic, foam, and trade show lexan, the image can be selected from full background, ghosted center, fully ghosted and white center, and the finishing can be selected from mount to magnetic, contour cuts, ropes in hems, hems and grommets and pole pockets. The added printed matter and other graphics can be printed with a full color printer.

From the foregoing summary, it can be observed that a primary objective of the present invention is to provide a process for making fully or partially custom designed signage such as poster and banners that can be produced and sold at lower prices usually associated with such products even when produced in small or relatively small volumes.

Another objective of the present invention is to provide a variety of images that can be horizontally or vertically oriented.

Yet another objective of the present invention is to provide a process to make single and double sided light post banners, hanging banners and banners for various kinds of free-standing holders.

Still another objective of the present invention is to provide a process for making small banner quantities at an affordable price and yet make larger quantities at a competitive price.

Yet another further objective of the present invention is to provide a library of images that include textures, seasons, celebrations, food, music, sports and holidays.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention, which is measured by its claims, nor to limit its scope in any way.

Thus, the objects of the invention set forth above, along with the various features of novelty which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views.

The drawings are included to provide a further understanding of the invention and are incorporated in and constitute a part of this specification. They illustrate embodiments of the invention and, together with their description, serve to explain the principles of the invention.

### BRIEF DESCRIPTION OF THE DRAWINGS

FIG. 1 is a block diagram of the process of the present invention wherein the supplier produces the entire signage including printed and other graphic material;

FIG. 2 is a block diagram of the process of the present invention wherein the desired graphics are applied by the party selecting the background finished media;

FIG. 3 front elevational view of a single light post banner graphically identifying the dates of an event;

FIG. 4 is a front elevational view of double light post banners suggesting a seasonal and a musical theme;

FIG. 5 is a front elevational view of a wave-shaped banner produced by the method of the invention; and

FIG. 6 is a front elevational view of a banner displaying a baseball theme produced by the method of the present invention.

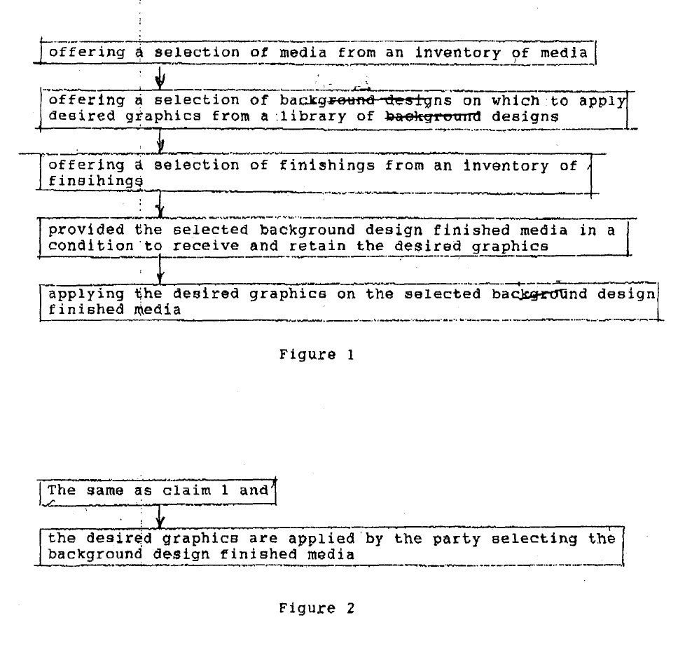

### DETAILED DESCRIPTION OF THE PREFERRED EMBODIMENT

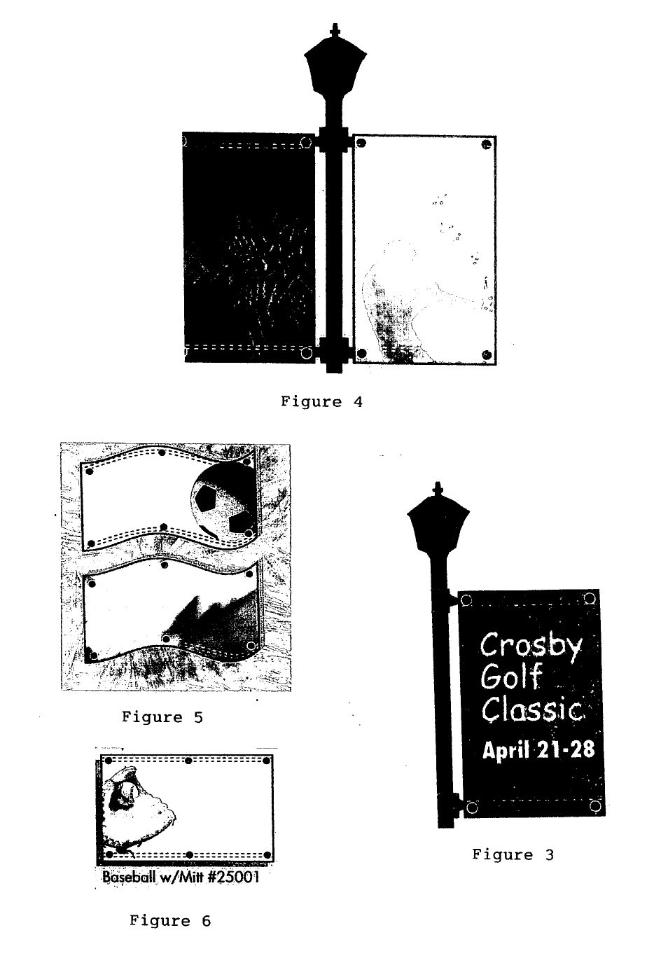

The present invention utilizes color images viewed in library or catalogue form to print on signs in a choice of media with a selected finishing. The banner designated 10 in FIG. 6 displays a baseball theme and includes hems 12 and grommets 14 as a finishing. It can be printed with outdoor durable inks for fade resistance and water fastness. Media include, but are not limited to, banner material, adhesive vinyl, canvas, paper, corrugated plastic, foam, trade show lexan and backlit media. Other finishings are mount to magnetic, contour cut (FIG. 5), ropes in hems and pole pockets (used in the banners shown in FIGS. 3 and 4).

The process of the invention is for preparing customized signage and includes the steps of offering a selection of media which may include but not be limited to banner material, adhesive vinyl, canvas, paper, corrugated plastic, foam and trade show lexan, offering a selection of images from a library of designs with themes such as textures, seasons, celebrations, food, music, sports and holidays, offering a selection of finishings from an inventory of finishings including, but not limited to, mount to magnetic, contour cuts, ropes in hems, hems and grommets and pole pockets, providing the selected image design finished media in a condition to receive and retain the desired graphics, and applying the desired graphics on the selected image with the selected finish.

The process may be carried out by the supplier of the media, image and finishing applying the desired graphics by a full color printer or by the party selecting the media, image, and finishing either applying the desired graphics onto the selected background media with the selected image or having a contract printer or signmaker make that application.

The process of the present invention can be practiced, for example, by the supplier establishing a website on the internet and making available the media, image, and finishing options so that a customer seeking customized signage can design the product at the website. The supplier can then download the designed product and deliver it to the customer along with whatever other documents or materials are appropriate.

It is to be understood that the signage made by the process of the present invention are shown herein for illustrative purposes and do not represent all of the products capable of being made by such process. Other forms of display products may be provided by the media, design and finishing selection process described herein and still be within the inventive concept. It is intended that the invention be limited only by the scope of the appended claims rather than by the details of the form shown.

What is claimed is:

1. A process for preparing customized signs comprising the steps of: offering a selection of media on which to apply desired graphics from an inventory of different media; offering a library of images to be printed on the selected media; offering a selection of finishings from an inventory of finishings; providing the selected image finished media in a condition to receive and retain the desired graphics; and applying the desired graphics to the selected image finished media.

2. The process as claimed in claim 1 wherein the desired graphics are applied by the party selecting the image finished media.

3. The process as claimed in claim 1 wherein the desired graphics are applied by the party furnishing the background design finished media.

4. The process as claimed in claim 1 wherein the selected media, image and finishing are printed with a color printer.

5. The process as claimed in claim 2 wherein the selected media, image and finishing are printed with a color printer.

6. The process as claimed in claim 3 wherein the selected media, image and finishing are printed with a color printer.

7. The process as claimed in claim 1 wherein the background design is in color.

8. The process as claimed in claim 2 wherein the background design is in color.

9. The process as claimed in claim 3 wherein the background design is in color.

10. The process as claimed in claim 1 wherein media is suitable, for outdoor use.

11. The process as claimed in claim 2 wherein the media is suitable for outdoor use.

12. The process as claimed in claim 3 wherein the media is suitable for outdoor use.

13. The process as claimed in claim 1 wherein the media includes banner material, adhesive vinyl, canvas, paper, corrugated plastic, foam, and trade show lexan, the finishing includes mount to magnetic, contour cut, ropes in hems, hems and grommets and pole pockets and the images include fill background, ghosted center, fully ghosted and white center.

14. The process as claimed in claim 2 wherein the media includes banner material, adhesive vinyl, canvas, paper, corrugated plastic, foam, and trade show lexan, the finishing includes mount to magnetic, contour cuts, ropes in hems, hems and grommets and pole pockets and the images include full background, ghosted center, fully ghosted and white center.

15. The process as claimed in claim 3 wherein the media includes banner material, adhesive vinyl, canvas, paper, corrugated plastic, foam, and trade show lexan, the finishing includes mount to magnetic, contour cuts, ropes in hems, hems and grommets and pole pockets and the images include full background, ghosted center, fully ghosted center and white center.
process as claimed in claim 13 wherein the selected graphics is printed with a color printer and the selected media is suitable for outdoor use.

17. The process as claimed in claim 14 wherein the selected graphics is printed with a color printer and the selected media is suitable for outdoor use.

18. The process as claimed in claim 15 wherein the selected graphics is printed with a color printer and the selected media is suitable for outdoor use.
